(19) United States
(12) Patent Application Publication
(10) Pub. No.: US 2009/0269727 A1
(43) Pub. Date: Oct. 29, 2009

(54) NETWORK APPARATUS, SYSTEM AND METHOD FOR TEACHING MATH

(76) Inventors: Brad Gary Asplund, Taylorsville, UT (US); Jason Asplund, West Jordan, UT (US)

Correspondence Address: TERRENCE J. EDWARDS;CLAYTON, HOWARTH & CANNON, P.C., P.O. BOX 1909, SANDY, UT, 84091, US

(21) Appl. No.: 12/125,039

(22) Filed: May 21, 2008

Related U.S. Application Data
(60) Provisional application No. 61/048,135, filed on Apr. 25, 2008.

(51) Int. Cl. G09B 19/02

(52) U.S. Cl. 434/188

(57) ABSTRACT

A network for teaching mathematics having a teacher device for forming a mathematical query networked to a student device for receiving the input data from a student on a network is disclosed. The student device on the network may use a numerical key pad for entering mathematical solutions and a display for seeing the input. Additionally, a method for networking students and teachers for mathematics comprising forming a mathematical query on a teacher device and receiving data from a student device related to the formed query over a network with the teacher device is disclosed.

### CROSS-REFERENCE TO RELATED APPLICATIONS

This application claims the benefit of U.S. Provisional Application No. 61/048,135, filed Apr. 25, 2008, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

1. The Field of the Invention

The system, method and apparatus of the disclosure relates generally to a network type of structuring for mathematics, and relates particularly to a system for teaching students to perform arithmetic rapidly in their heads and interacting with an administrator over a network.

2. Description of Related Art

Text book and front of the room lecture still remains the primary method of teaching mathematics to children. Many educators and caretakers of children believe that better teaching methods are needed for children to remain competitive in a world economy. For example, many text books are configured to teach concepts such as counting or number sense, place value and the arithmetic operations of addition, subtraction, multiplication and division with the use of an instructional portion of each section, a few examples, and then problems for solving to finalize the section material. Other tools such as computers and calculators leave the basics completely up to the machine. These systems neglect the need for on the feet thinking that the real world situations require like in stress induced situations where rapid and spontaneous arithmetic is needed or desired. What is needed is a system that teaches students in a real time format with the addition of adjustable pressure levels and where visuals are employed to better simulate real world situations.

The disclosure minimizes, and in some aspects eliminates, the above-mentioned failures, and other problems, by utilizing the system, method and apparatus described herein.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### SUMMARY OF THE DISCLOSURE

While other mathematics education systems, such as text books, can be used to teach various foundational mathematical concepts and arithmetic, such systems often fail to teach or adequately emphasize how to sequence or order numbers and mathematical symbols effectively mentally to solve problems on the fly. Teachers and administrators are better able to adjust teaching methods and track student progress once they know the status or ability of a student. For example, in a setting where a teacher is provided with real time data during a test, the teacher can determine and identify where a student is having problems. The real time data may be in the form of timing, efficiency, number correct, number missed and time based data or the period of the test. Additionally, a teacher may be able to adjust the nature of the exam to maximize the experience for the student. For example, if the student is moving too slow the problems asked may be adjusted to improve the testing experience for that particular student. Alternatively, if a student is moving too fast the teacher can make the problems more challenging. These dynamic data streams may be recorded within a computer system where the computer system further quantifies the data into usable information for administrators. For example, a student may be easily tracked within the system over the school year by mapping the student's sessions in the system.

Accordingly, one embodiment of a network education system may comprise a student electronic device comprising a display, a processor, memory and input structure, such as for example a number pad. The device may be inexpensive and may be deployed to a plurality of students simultaneously. During a use session the student may listen or see stimuli in the form of a math problem and after developing the answer the student enters the answer on the student device and it is stored in memory on the device. The data may then be uploaded to a central system or accessed on the device.

Accordingly, one embodiment of a network education system may comprise a student electronic device comprising a display, a processor, memory and input structure, such as for example a number pad. The device may be inexpensive and may be deployed to a plurality of students simultaneously. During a use session the student may listen or see stimuli in the form of a math problem and after developing the answer the student enters the answer on the student device and it is stored in memory on the device. In a typical setting, a plurality or string of questions may be offered by the administrator requiring the user to put in a plurality of answers in a looped configuration. In a looped configuration the iteration time may be recorded into memory. The data may then be uploaded to a central system or accessed on the device.

Accordingly, one embodiment of a network education system may comprise a student electronic device comprising a display, a processor, memory and input structure, such as for example a number pad. The device may be inexpensive and may be deployed to a plurality of students simultaneously. During a use session the student may listen or see stimuli in the form of a math problem and after developing the answer the student enters the answer on the student device and it is stored in memory on the device. In a typical test setting a plurality or string of questions may be offered by the administrator requiring the user to put in a plurality of answers in a looped configuration. In a looped configuration the iteration time may be recorded into memory and processor may use the timing and answer data to form secondary statistical data of the students session. The secondary statistical data may then be uploaded to a central system or accessed on the device.

Accordingly, one embodiment of a network education system may comprise a student electronic device comprising a display, a processor, network communication device, memory and input structure such as for example a number pad. The device may be inexpensive and may be deployed to a plurality of students simultaneously each having a unique identifier. During a use session the student may hear or see stimuli in the form of a math problem and after developing the answer the student enters the answer, as data, into the student device. The data is stored in memory on the device or transmitted onto the network tagged with identifying information.

Accordingly, one embodiment of a network education system may comprise a student electronic device comprising a display, a processor, a network communication device, memory and input structure such as for example a number pad. The device may be inexpensive and may be deployed to a plurality of students simultaneously each having a unique identifier. During a use session the student may hear or see stimuli in the form of a math problem and after developing the answer the student enters the answer, as data, into the student device. The data is stored in memory on the device or transmitted onto the network tagged with identifying information. A plurality of iterations of this process may be used in strings or runs for a plurality of math expressions.

Accordingly, one embodiment of a network education system may comprise a student electronic device comprising a display, a processor, network communication device, memory and input structure such as for example a number pad. The device may be inexpensive and may be deployed to a plurality of students simultaneously each having a unique identifier. During a use session the student may hear or see stimuli in the form of a math problem and after developing the answer the student enters the answer, as data, into the student device. The data is stored in memory on the device or transmitted onto the network tagged with identifying information. Timing data may be transmitted onto the network. A plurality of iterations of this process may be used in strings or runs for a plurality of math expressions.

Accordingly, one embodiment of a network education system may comprise a student electronic device comprising a display a processor, network communication device, memory and input structure such as for example a number pad. The device may be inexpensive and may be deployed to a plurality of students simultaneously each having a unique identifier. During a use session the student may hear or see stimuli in the form of a math problem and after developing the answer the student enters the answer, as data, into the student device. The data is stored in memory on the device or transmitted onto the network tagged with identifying information. Timing data may be transmitted onto the network. A plurality of iterations of this process may be used in strings or runs for a plurality of math expressions. Timing data and answer data for each iteration may be received by an administration device that may store the data in an array within computer memory. The data may then be processed by a processor in the administration device to produce secondary data indicative of student progress and correlated to the unique network identifier of the device. A determination may be made as to the progress of the student and entered into the next iteration.

Accordingly, one embodiment of a network education system may have a server with memory containing a first array comprising a plurality of slots, wherein each slot may be assigned a predetermined value. Additionally, the memory may include another, second array having a plurality of slots, wherein each of these slots may be occupied by a mathematical operator. The memory may also have a third array with a plurality of slots, wherein each slot may be filled with the resultant of a value from the first array and an operator from the second array. The server may also output the resultants from the arrays to a user. These arrays may be filled with a looped randomizing process or predetermined.

An embodiment of a mathematics education system may have a first array comprising a plurality of slots, wherein each slot may be assigned a predetermined value. Additionally, the system may have another, second array having a plurality of slots, wherein each of these slots may be occupied by a mathematical operator. The system may also have a third array with a plurality of slots, wherein each slot may be filled with the resultant of a value from the first array and an operator from the second array. The system may also output the resultants from the third array to a user. The mathematics education system may also fill an array with integers.

Accordingly, one embodiment of a mathematics education system may have a first array comprising a plurality of slots, wherein each slot may be assigned a predetermined value. Additionally, the system may another, second array having a plurality of slots, wherein each of these slots may be occupied by a mathematical operator. The system may also have a third array with a plurality of slots, wherein each slot may be filled with the resultant of a value from the first array and an operator from the second array. The system may also output the resultants from the third array to a user. The mathematics education system may choose the mathematical operators of the second array from the group including addition (plus), subtraction (minus), multiplication, division, fractions and decimals.

An embodiment of a mathematics education system may have a first array comprising a plurality of slots, wherein each slot may be assigned a predetermined value. Additionally, the system may have another, second array having a plurality of slots, wherein each of these slots may be occupied by a mathematical operator. The system may also have a third array with a plurality of slots, wherein each slot may be filled with the resultant of a value from the first array and an operator from the second array. The system may also output the resultants from the third array to a user. The mathematics education system may also choose to fill an array with integers and may include both positive and negative integers.

Accordingly, one embodiment of a mathematics education system may have a first array comprising a plurality of slots, wherein each slot may be assigned a predetermined value. Additionally, the system may have another, second array having a plurality of slots, wherein each of these slots may be occupied by a mathematical operator. The system may also have a third array with a plurality of slots, wherein each slot may be filled with the resultant of a value from the first array and an operator from the second array. The system my also output the resultants from the third array to a user. The mathematics education system may also include resultants from the third array that may be entered into slots of the first array in a second iteration of the system.

Accordingly, one embodiment of a mathematics education system may have a first array comprising a plurality of slots, wherein each slot may be assigned a predetermined value. Additionally, the system may have another, second array having a plurality of slots, wherein each of these slots may be occupied by a mathematical operator. The system may also have a third array with a plurality of slots, wherein each slot may be filled with the resultant of a value from the first array and an operator from the second array. The system may also output the resultants from the third array to a user. The mathematics education system may also include resultants from the third array that may be entered into slots of the first array in a second or many iterations.

Accordingly, one embodiment of a mathematics education system may have a first array comprising a plurality of slots, wherein each slot may be assigned a predetermined value. Additionally, the system may have another, second array having a plurality of slots, wherein each of these slots may be occupied by a mathematical operator. The system may also have a third array with a plurality of slots, wherein each slot may be filled with the resultant of a value from the first array and an operator from the second array. The system may also output the resultants from the third array to a user. The value of the first array may be placed on a visual medium.

Accordingly, one embodiment of a mathematics education system may have a first array comprising a plurality of slots, wherein each slot may be assigned a predetermined value. Additionally, the system may have another, second array having a plurality of slots, wherein each of these slots may be occupied by a mathematical operator. The system may also have a third array with a plurality of slots, wherein each slot may be filled with the resultant of a value from the first array and an operator from the second array. The system my also output the resultants from the third array to a user. The value of the second array may be placed on a visual medium.

Accordingly, one embodiment of a mathematics education system may have a first array comprising a plurality of slots, wherein each slot may be assigned a predetermined value. Additionally, the system may have another, second array having a plurality of slots, wherein each of these slots may be occupied by a mathematical operator. The system may also have a third array with a plurality of slots, wherein each slot may be filled with the resultant of a value from the first array and an operator from the second array. The system my also output the resultants from the third array to a user. The value of the first array and the value of the second array may also be placed on a visual medium.

Accordingly, one embodiment of a mathematics education system may have a first array comprising a plurality of slots, wherein each slot may be assigned a predetermined value. Additionally, the system may have another, second array having a plurality of slots, wherein each of these slots may be occupied by a mathematical operator. The system may also have a third array with a plurality of slots, wherein each slot may be filled with the resultant of a value from the first array and an operator from the second array. The system may also output the resultants from the third array to a user. A container may also be used where objects representing integers may be used for visual cues within the system and where the objects may be placed in and out of the container.

Accordingly, one embodiment of a mathematics education system may have a first array comprising a plurality of slots, wherein each slot may be assigned a predetermined value. Additionally, the system may have another, second array having a plurality of slots, wherein each of these slots may be occupied by a mathematical operator. The system may also have a third array with a plurality of slots, wherein each slot may be filled with the resultant of a value from the first array and an operator from the second array. The system my also output the resultants from the third array to a user. A container may also be used where objects representing integers may be used for visual cues within the system and where the objects may be placed in and out of the container. The objects may be placed in the container or may be moved out of the container or placed into the container by a user.

Accordingly, one embodiment of a computer readable memory comprising instructions for a computer for a mathematics education system may have a first computer data base array comprising a plurality of slots, and wherein each slot may be occupied with a predetermined value. The memory may also have a second computer data array comprising a plurality of slots, wherein each slot may be occupied by a mathematical operator. There may also be a third computer data array comprising a plurality of slots, wherein each slot may be filled with the resultant of a value from the first array and an operator from the second array and the array may be outputted to a user.

Accordingly, one embodiment of a computer readable memory comprising instructions for a computer for a mathematics education system may have a first computer data base array comprising a plurality of slots, and wherein each slot may be occupied with a predetermined value. The memory may also have a second computer data array comprising a plurality of slots, wherein each slot may be occupied by a mathematical operator. There may also be a third computer data array comprising a plurality of slots, wherein each slot may be filled with the resultant of a value from the first array and an operator from the second array and the array may be outputted to a user, and the values of the first array may be chosen from integers and outputted to a user.

Accordingly, one embodiment of a computer readable memory comprising instructions for a computer for a mathematics education system may have a first computer data base array comprising a plurality of slots, and wherein each slot may be occupied with a predetermined value. The memory may also have a second computer data array comprising a plurality of slots, wherein each slot may be occupied by a mathematical operator. There may also be a third computer data array comprising a plurality of slots, wherein each slot may be filled with the resultant of a value from the first array and an operator from the second array and the array may be outputted to a user, and the mathematical operators of the second array may be chosen from the group including addition (plus), subtraction (minus), multiplication, division, fractions and decimals and output to a user.

Accordingly, one embodiment of a computer readable memory comprising instructions for a computer for a mathematics education system may have a first computer data base array comprising a plurality of slots, and wherein each slot may be occupied with a predetermined value. The memory may also have a second computer data array comprising a plurality of slots, wherein each slot may be occupied by a mathematical operator. There may also be a third computer data array comprising a plurality of slots, wherein each slot may be filled with the resultant of a value from the first array and an operator from the second array and the array may be outputted to a user, and the resultants from the third array may be entered into slots of the first array in a second iteration of the system.

Accordingly, one embodiment of a computer readable memory comprising instructions for a computer for a mathematics education system may have a first computer data base array comprising a plurality of slots, and wherein each slot may be occupied with a predetermined value. The memory may also have a second computer data array comprising a plurality of slots, wherein each slot may be occupied by a mathematical operator. There may also be a third computer data array comprising a plurality of slots, wherein each slot may be filled with the resultant of a value from the first array and an operator from the second array and the array may be outputted to a user, and may have a vessel or container and objects representing integers used for visual cues within the system.

Accordingly, one embodiment of a computer readable memory comprising instructions for a computer for a mathematics education system may have a first computer data base array comprising a plurality of slots, and wherein each slot may be occupied with a predetermined value. The memory may also have a second computer data array comprising a plurality of slots, wherein each slot may be occupied by a mathematical operator. There may also be a third computer data array comprising a plurality of slots, wherein each slot may be filled with the resultant of a value from the first array and an operator from the second array and the array may be outputted to a user, and may have a vessel or container and objects representing integers used for visual cues within the system. The system may also have a vessel or container and objects that may be computer generated.

Accordingly, one embodiment of a computer readable memory comprising instructions for a computer for a mathematics education system may have a first computer data base array comprising a plurality of slots, and wherein each slot may be occupied with a predetermined value. The memory may also have a second computer data array comprising a plurality of slots, wherein each slot may be occupied by a mathematical operator. There may also be a third computer data array comprising a plurality of slots, wherein each slot may be filled with the resultant of a value from the first array and an operator from the second array and the array may be outputted to a user, and may have a vessel or container and objects representing integers used for visual cues within the system. The system may also have a vessel or container and objects that may be computer generated and may be moved into and out of the vessel or container digitally on a computer display.

Accordingly, one embodiment of a network of computers having memory comprising instructions for a mathematics education system for causing the processor to form a first computer data base array comprising a plurality of slots, wherein each slot may be occupied with a predetermined value. Additionally, a second computer data array may be formed comprising a plurality of slots, wherein each slot may be occupied by a mathematical operator. Further, a third computer data array may be formed comprising a plurality of slots, wherein each slot may be filled with the resultant of a value from the first array and an operator from the second array and the resultants from the third array may be output from the system.

Accordingly, one embodiment of a network of computers having memory comprising instructions for a computer for a mathematics education system may have a first computer data base array comprising a plurality of slots, and wherein each slot may be occupied with a predetermined value. The memory may also have a second computer data array comprising a plurality of slots, wherein each slot may be occupied by a mathematical operator. There may also be a third computer data array comprising a plurality of slots, wherein each slot may be filled with the resultant of a value from the first array and an operator from the second array and the array may be outputted to a user.

Accordingly, one embodiment of a network of computers having memory comprising instructions for a computer for a mathematics education system may have a first computer data base array comprising a plurality of slots, and wherein each slot may be occupied with a predetermined value. The memory may also have a second computer data array comprising a plurality of slots, wherein each slot may be occupied by a mathematical operator. There may also be a third computer data array comprising a plurality of slots, wherein each slot may be filled with the resultant of a value from the first array and an operator from the second array and the array may be outputted to a user, and the values of the first array may be chosen from integers and output to a user.

Accordingly, one embodiment of a network of computers having memory comprising instructions for a computer for a mathematics education system may have a first computer data base array comprising a plurality of slots, and wherein each slot may be occupied with a predetermined value. The memory may also have a second computer data array comprising a plurality of slots, wherein each slot may be occupied by a mathematical operator. There may also be a third computer data array comprising a plurality of slots, wherein each slot may be filled with the resultant of a value from the first array and an operator from the second array and the array may be outputted to a user, and the mathematical operators of the second array may be chosen from the group including addition (plus), subtraction (minus), multiplication, division, fractions and decimals and output to a user.

Accordingly, one embodiment of a network of computers having memory comprising instructions for a computer for a mathematics education system may have a first computer data base array comprising a plurality of slots, and wherein each slot may be occupied with a predetermined value. The memory may also have a second computer data array comprising a plurality of slots, wherein each slot may be occupied by a mathematical operator. There may also be a third computer data array comprising a plurality of slots, wherein each slot may be filled with the resultant of a value from the first array and an operator from the second array and the array may be outputted to a user, and the resultants from the third array may be entered into slots of the first array in a second iteration of the system.

Accordingly, one embodiment of a network of computers having memory comprising instructions for a computer for a mathematics education system may have a first computer data base array comprising a plurality of slots, and wherein each slot may be occupied with a predetermined value. The memory may also have a second computer data array comprising a plurality of slots, wherein each slot may be occupied by a mathematical operator. There may also be a third computer data array comprising a plurality of slots, wherein each slot may be filled with the resultant of a value from the first array and an operator from the second array and the array may be outputted to a user, and may have a vessel or container and objects representing integers used for visual cues within the system.

Accordingly, one embodiment of a computer readable memory comprising instructions for a computer for a mathematics education system may have a first computer data base array comprising a plurality of slots, and wherein each slot may be occupied with a predetermined value. The memory may also have a second computer data array comprising a plurality of slots, wherein each slot may be occupied by a mathematical operator. There may also be a third computer data array comprising a plurality of slots, wherein each slot may be filled with the resultant of a value from the first array and an operator from the second array and the array may be outputted to a user, and may have a vessel or container and objects representing integers used for visual cues within the system. The system may also have a vessel or container and objects that may be computer generated.

Accordingly, one embodiment of a network of computers having memory comprising instructions for a computer for a mathematics education system may have a first computer data base array comprising a plurality of slots, and wherein each slot may be occupied with a predetermined value. The memory may also have a second computer data array comprising a plurality of slots, wherein each slot may be occupied by a mathematical operator. There may also be a third computer data array comprising a plurality of slots, wherein each slot may be filled with the resultant of a value from the first array and an operator from the second array and the array may be outputted to a user, and may have a vessel and objects representing integers used for visual cues within the system. The system may also have a vessel and objects that may be computer generated and may be moved into and out of the vessel digitally on a computer display.

According to another embodiment of the disclosure, a mathematics education kit that may have a network of computers, computer readable memory comprising instructions for a computer for a mathematics education system that may form a first computer data base array comprising a plurality of slots, and wherein each slot may be occupied with a predetermined value. The memory may also have formed a second computer data array comprising a plurality of slots, wherein each slot may be occupied by a mathematical operator. There may also be formed a third computer data array comprising a plurality of slots, wherein each slot may be filled with the resultant of a value from the first array and an operator from the second array and the array may be outputted to a user. There may also be included in the kit a vessel or container and objects representing integers for use as visual cues during use of the system.

### BRIEF DESCRIPTION OF THE DRAWINGS

Embodiments of the disclosure are described below will be in reference to the following figures, which are intended to be illustrative and not limiting.

FIG. 1 is an illustration of an exemplary embodiment of a network for teaching mathematics as described herein;

FIG. 2 is an illustration of an exemplary embodiment of a network for teaching mathematics as described herein;

FIG. 3 is an illustration of an exemplary embodiment of a system for teaching a mathematical system as described herein;

FIG. 4 is an illustration of an exemplary embodiment of a network for teaching mathematics as described herein;

FIG. 5 is an illustration of an exemplary embodiment of a network for teaching mathematics as described herein;

FIG. 6 is an illustration of an exemplary embodiment a device for use within a network for teaching mathematics as described herein;

FIG. 7 is an illustration of an exemplary embodiment of an admin or teacher device or station for use within a network for teaching mathematics as described herein;

FIG. 8 is an illustration of an exemplary embodiment of a network for teaching mathematics as described herein;

FIG. 9 is an illustration of an exemplary embodiment of a network for teaching mathematics as described herein;

FIG. 10 is an illustration of an exemplary embodiment of a network for teaching mathematics as described herein;

FIG. 11 is an illustration of an exemplary embodiment of a network for teaching mathematics as described herein;

FIG. 12 is an illustration of an exemplary embodiment of a network for teaching mathematics as described herein;

FIG. 13 is an illustration of an exemplary embodiment of a network for teaching mathematics as described herein; and

FIG. 14 is an illustration of an exemplary embodiment of a network for teaching mathematics as described herein.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before discussing the details of the disclosure, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present disclosure will be limited only by the appended claims and equivalents thereof.

It must be noted that, as used in this specification and the appended claims, the singular forms “a,” “an,” and “the” include plural referents unless the context clearly dictates otherwise.

In describing and claiming the present disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

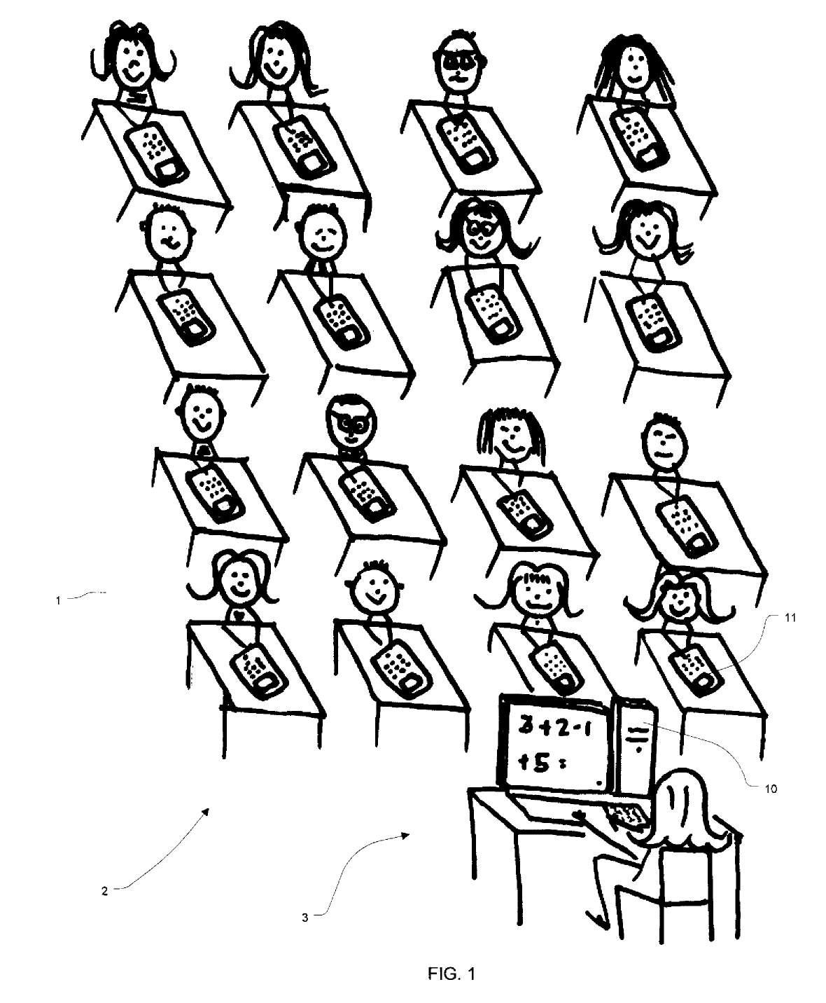

An exemplary embodiment of a network for teaching math is illustrated in FIG. 1. A network for teaching math 1 may comprise a student body 2 and an administration station 3 as networked components communication over a traditional computer network utilizing network adaptors and protocols locally or remotely. Among the typical network components in this embodiment may be servers 10 for processing computer instructions placed in memory or storage that causes a processor to perform the steps of the system as discussed above. A network infrastructure both lined and wireless may be used with each device on the network using common or proprietary software and hardware to connect to the network. Additionally, a plurality of work stations or devices 11 may be connected to the network for administering the math learning system to a student body 2 concurrently. The network my be deployed within a room, a school, over the internet to include any connected portion of the world such that many users may be connected over the same network.

Consistent with having multiple users on the system concurrently, competitions among students, schools and any other groups my be facilitated. For example, the system may send out an iteration from the central server 10 to student devices 11 simultaneously over the network 1. Each student would input their solution and the terminal that returns the fastest time for a correct answer would indicate the winner. A dedicated device 11 my be employed such as a dedicated tablet or PDA that may have a simple user interface for reporting answers and timing data back to the administering server 10. The process for making a query and receiving student answers may comprise a plurality of individual arrays each having a plurality of receiving slots. The slots be identified in a way that is typical of an array, such as two coordinate values that may identify a depth laterally and a depth vertically. Any array formation method commonly known is within the scope of the disclosure. Although the illustrated first array comprises positive integers, first arrays having other combinations of negative or imaginary integers can be used in other embodiments. For example, a base array with negative numbers in receiving slots can be used to teach more advanced arithmetic.

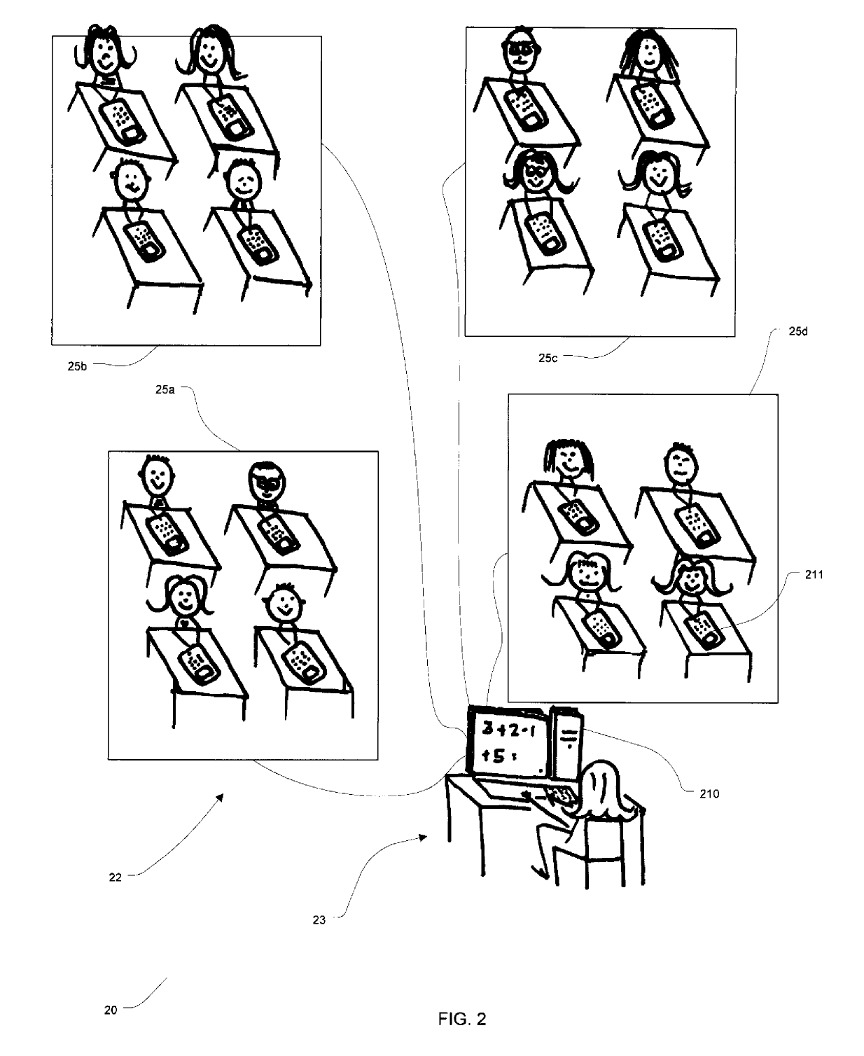

In the exemplary embodiment illustrated in FIG. 2, a network for teaching math 20 may comprise a student body 22 and an administration station 23 as networked components communication over a traditional computer network utilizing network adaptors and protocols locally or remotely. Among the typical network components in this embodiment may be servers 210 for processing computer instructions placed in memory or storage that causes a processor to perform the steps of the system as discussed above. A network infrastructure both lined and wireless may be used with each device on the network using common or proprietary software and hardware to connect to the network. Additionally, a plurality of clusters 25a, 25b, 25c, 25d of work stations or devices may be connected to the network for administering the math learning system to a student body 22 concurrently. The clusters 25a, 25b, 25c, 25d may be used to group students with like abilities or to separate students with like abilities. The clustering may be used for administration purposes or ease of implementation. The clustering may also be used for teaming students into groups. The network my be deployed within a room, a school, over the internet to include any connected portion of the world such that many users may be connected over the same network.

Consistent with having multiple users on the system concurrently, competitions among students, schools and any other groups my be facilitated. For example, the system may send out an iteration from the central server 210 to student devices 211 simultaneously over the network 20. Each student would input their solution and the terminal that returns the fastest time for a correct answer would indicate the winner. A dedicated device 211 my be employed such as a dedicated tablet or PDA that may have a simple user interface for reporting answers and timing data back to the administering server 210.

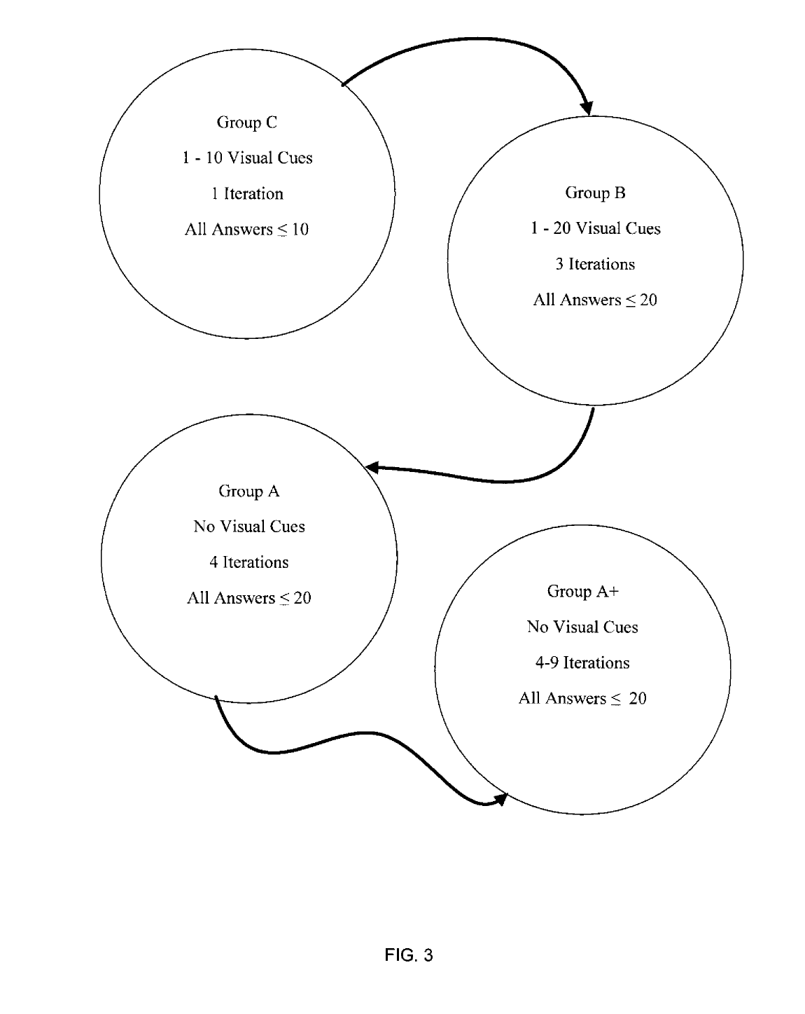

FIG. 3 illustrates a system for clustering students within the mathematical system according to the number of iterations and values a particular student can perform. As a student progressively improves in ability, the system may be adjusted accordingly to maintain the level of learning. For example each student may start in Group C, which may include ten visual cues that may be numbered 1-10; 1 iteration of the system, which may include two numbers obtained from the first array and one operator obtained from the second array, wherein all of the answers to the problems posed may be less than or equal to 10. As a student achieves a predetermined level of success under the parameters of Group C, the student may advance to Group B.

Group B may include twenty visual cues that may be numbered 1-20. Group B may include problems using up to 3 iterations of the system, wherein each iteration may include two numbers obtained from the first array and one operator obtained from the second array, wherein all of the answers to the problems posed may be less than or equal to 20. As a student achieves a predetermined level of success under the parameters of Group B, the student may advance to Group A.

Group A may use no visual cues. Group A may include problems using up to 4 iterations of the system, wherein each iteration may include two numbers obtained from the first array and one operator obtained from the second array, wherein all of the answers to the problems posed may be less than or equal to 20. As a student achieves a predetermined level of success under the parameters of Group A, the student may advance to Group A+.

Group A+ may use no visual cues. Group A+ may include problems using between 4 and 9 iterations of the system, wherein each iteration may include two numbers obtained from the first array and one operator obtained from the second array, wherein all of the answers to the problems posed may be less than or equal to 20. By adjusting the group placement each student can progress at a pace that may be most advantageous for the student. Other groupings may be utilized, other than identified above, without departing from the spirit or scope of the present disclosure.

It will be appreciated that a competition may be held between the group of students from Group A+ to compete against other students of similar talent, knowledge and ability. Using the networking and systems disclosed herein, the competition may be held at one location or over a network with students attending the competition from multiple sites.

It will be appreciated that mathematical problems using the operators in the second array, including operators related to addition, subtraction, multiplication, division, fractions and decimals, may be taught to students, particularly in primary education, in any order. In one embodiment, students obtaining their primary education may be taught to use operators from the second array in a sequential order until the student has learned or mastered a given operator. In this embodiment, the sequential order of teaching the operators in the second array may be as follows: addition first, subtraction second, multiplication third, division fourth, fractions fifth and decimals sixth.

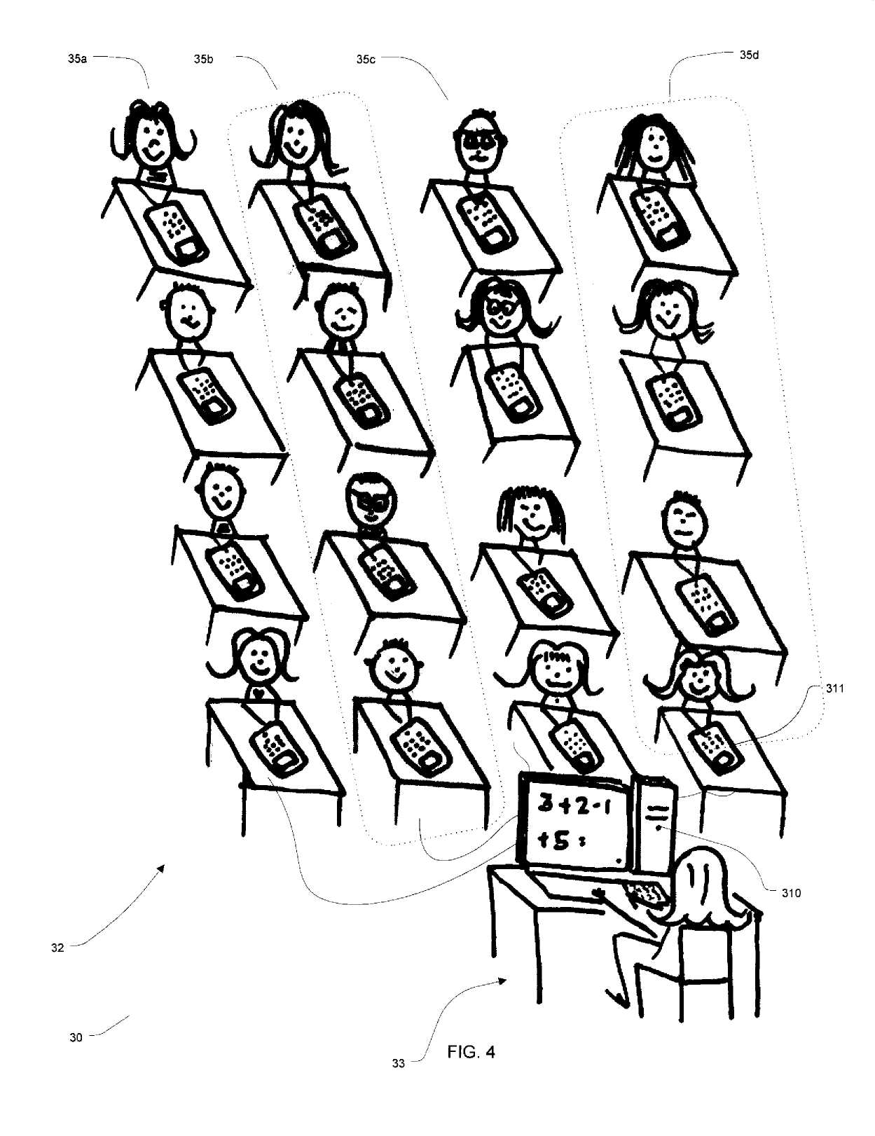

In the exemplary embodiment illustrated in FIG. 4, a network for teaching math 30 may comprise a student body 32 and an administration station 33 as networked components communication over a traditional computer network utilizing network adaptors and protocols locally or remotely. Among the typical network components in this embodiment may be servers 310 for processing computer instructions placed in memory or storage that causes a processor to perform the steps of the system as discussed above. A network infrastructure both lined and wireless may be used with each device on the network using common or proprietary software and hardware to connect to the network. Additionally, students may be clustered into a plurality of rows 35a, 35b, 35c, 35d of work stations or devices may be connected to the network for administering the math learning system to a student body 32 concurrently. The clusters 35a, 35b, 35c, 35d may be used to group students with like abilities or to separate students with like abilities. The clustering may used for administration purposes or ease of implementation. The clustering may also be used teaming students into groups. As illustrated in the figure rows may be used to allow for anonymity and ease the temptation to cheat by looking to the side because each row will get unique questions. The network my be deployed within a room, a school, over the internet to include any connected portion of the world such that many users may be connected over the same network.

Consistent with having multiple users on the system concurrently, competitions among students, schools and any other groups my be facilitated. For example, the system may send out an iteration from the central server 310 to student devices 311 simultaneously over the network 30. Each student would input their solution and the terminal that returns the fastest time for a correct answer would indicate the winner. A dedicated device 311 my be employed such as a dedicated tablet or PDA that may have a simple user interface for reporting answers and timing data back to the administering server 310.

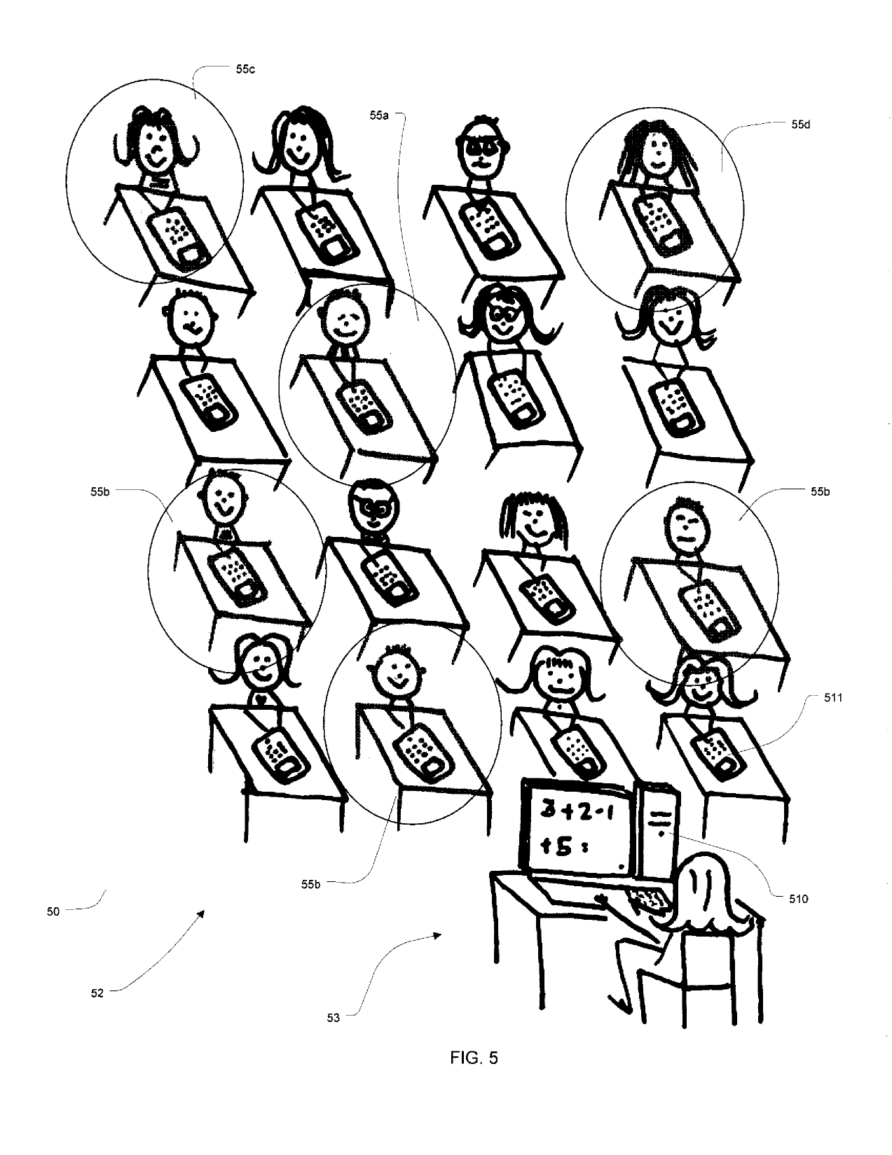

In the exemplary embodiment illustrated in FIG. 5, a network for teaching math 50 may comprise a student body 52 and an administration station 53 as networked components communication over a traditional computer network utilizing network adaptors and protocols locally or remotely. Among the typical network components in this embodiment may be servers 510 for processing computer instructions placed in memory or storage that causes a processor to perform the steps of the system as discussed above. A network infrastructure both lined and wireless may be used with each device on the network using common or proprietary software and hardware to connect to the network. Additionally, students may be randomly placed in the classroom but virtually grouped into a plurality of groups 55a, 55b, 55c, 55d of work stations or devices that may be connected to the network for administering the math learning system to a student body 52 concurrently. The virtual groups 55a, 55b, 55c, 55d may be used to group students with like abilities but provide anonymity. The virtual grouping may also be used teaming students into groups. As illustrated in the figure rows may be used to allow for anonymity and ease the temptation to cheat by looking to the side because each row will get unique questions. The network my be deployed within a room, a school, over the internet to include any connected portion of the world such that many users may be connected over the same network.

Consistent with having multiple users on the system concurrently, competitions among students, schools and any other groups my be facilitated. For example, the system may send out an iteration from the central server 510 to student devices 511 simultaneously over the network 50. Each student would input their solution and the terminal that returns the fastest time for a correct answer would indicate the winner. A dedicated device 511 my be employed such as a dedicated tablet or PDA that may have a simple user interface for reporting answers and timing data back to the administering server 510.

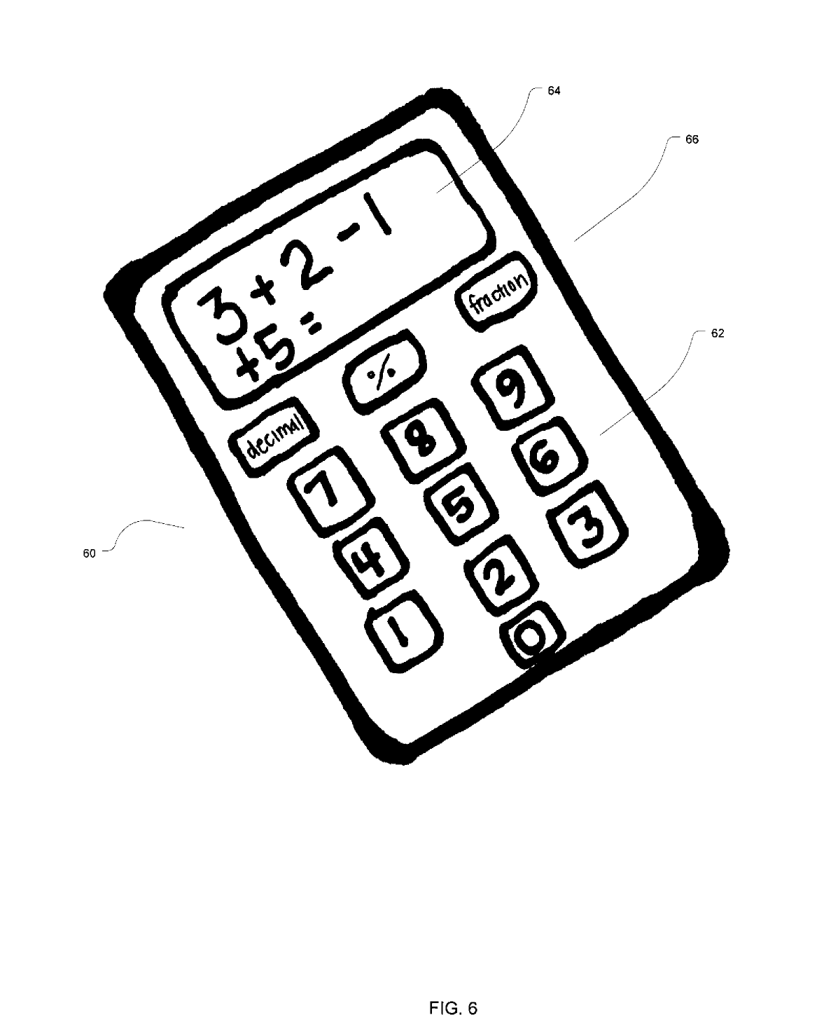

FIG. 6 illustrates an embodiment of a student device 60 for use within a network for teaching math. The student device 60 may be configured to work over the network with a unique identifier or address that will identify the device over the network. The student device may be configured to interface wirelessly or wired with the network. Internally, within the system the address of the student device may be assigned in memory to a student or seat in the classroom. The device may be equipped with a processor and memory for manipulating data and interfacing with input and output elements of the device 60. For inputting data into the device, there may be a number pad 62 and a operator pad 66. The number pad may include Brail compliant tactile bumps for the visually impaired. The device 60 may comprise a digital display 64 for conveying information to a user such as the math expression to be solved or feedback in the form of visual rewards. The device 60 may be configured with a speaker or other sound emitting device for providing audible ques and be compliant with handicap systems for the blind. It should be noted that the device may or may not be capable of performing like a calculator. This may be a feature that can be functioned on or off to suit the situation.

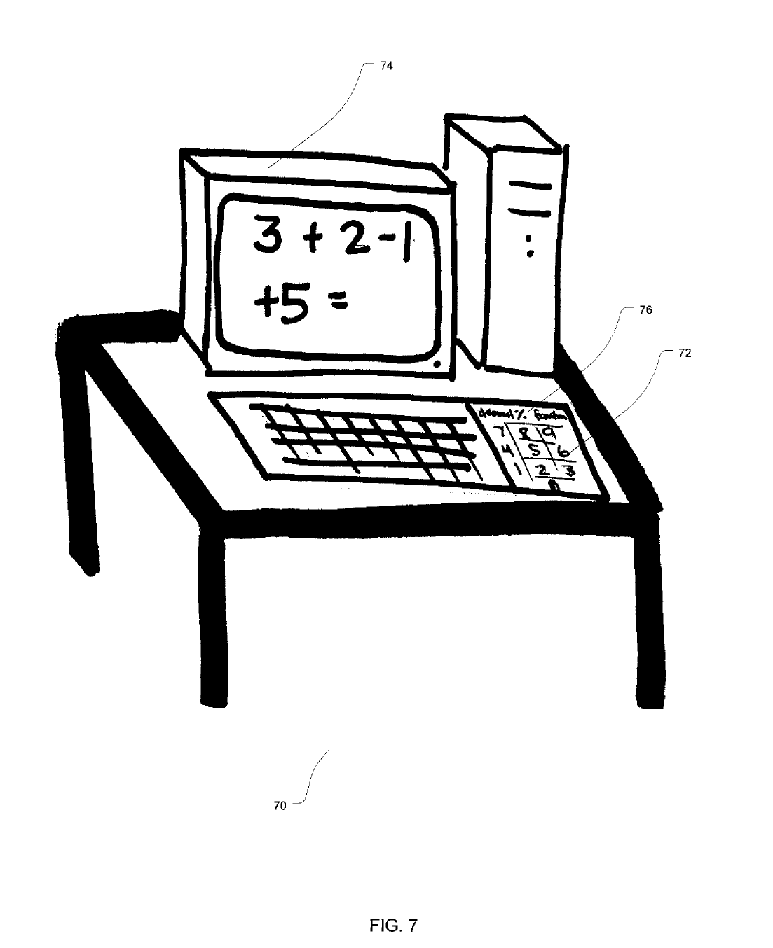

FIG. 7 illustrates an embodiment of an admin or teacher device or station 70 for use within a network for teaching math. The admin or teacher device or station 70 may be configured to work over the network with a unique identifier or address that will identify the device over the network. The admin or teacher device or station 70 may be configured to interface wirelessly or wired with the network. Internally, within the system the address of the admin or teacher device or station 70 may be assigned in memory to a take priority over the other devices on the network to control such things as time, updates, and data transfer. The admin or teacher device or station 70 may be equipped with a processor and memory for manipulating data from the student devices and interfacing with input and output elements of the admin or teacher device or station 70. The admin or teacher device or station 70 may act as the server for the network. For inputting data into the admin or teacher device or station 70 there may be a number pad 72 and a operator pad 76. The number pad may include Brail compliant tactile bumps for the visually impaired. The admin or teacher device or station 70 may comprise a digital display 74 for conveying information to a user such as the math expression to be solved or feedback in the form of visual rewards. The display 74 may show student device status and have a realtime data report dynamically shown. The admin or teacher device or station 70 may be configured with a speaker or other sound emitting device for providing audible ques and be compliant with handicap systems for the blind. It should be noted that the admin or teacher device or station 70 may or may not be capable of performing like a calculator. This may be a feature that can be functioned on or off to suit the situation. The admin or teacher device or station 70 may be handheld or a student device that has been switched to administrative mode.

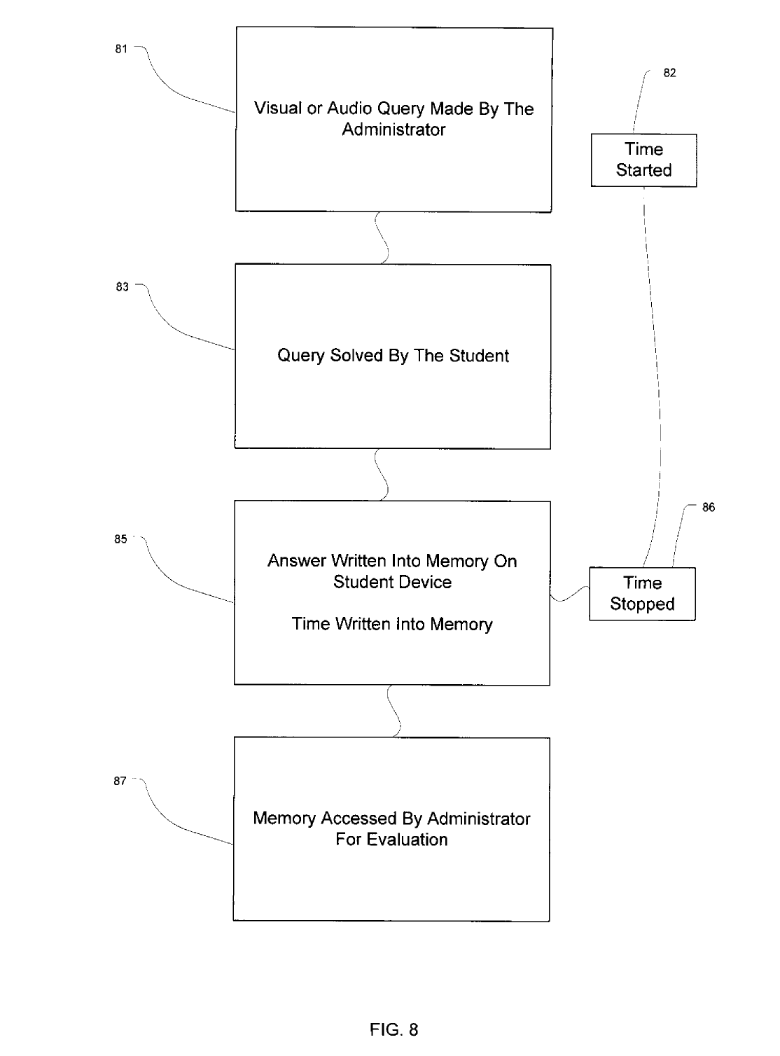

FIG. 8 illustrates an embodiment of a network for teaching math in use. At 81 an administrator initiates a math expression to be solved by the students. This may be done automatically by a computer and the numbers and operators may be generated randomly by a processor and a random generator. All of the student devices may be identified on the network and initialized to receive input, at 83 a student may enter a solution to the queried math expression on an input means of the student device. At 85 the student device writes the input to memory and makes a not of the time. After a testing or use session the memory of the student device may be accessed for review. An internal clock with in the device may record the time it took the student to input the solution by comparing a time taken at 82 and 86 on the diagram.

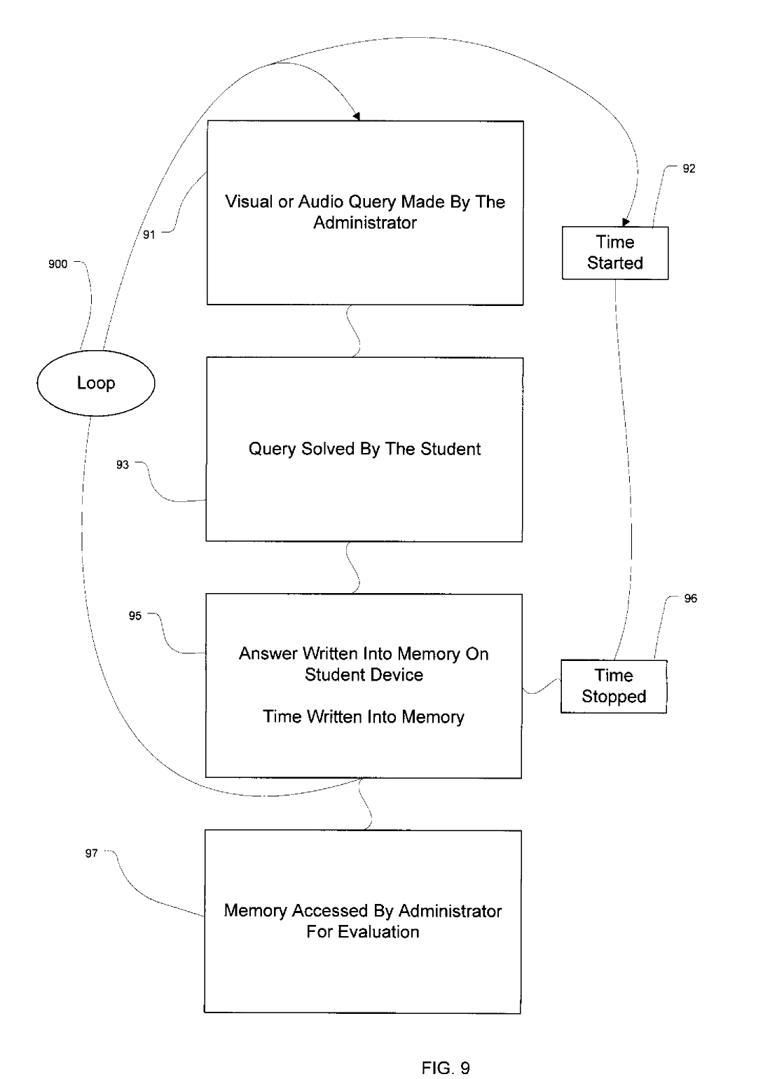

FIG. 9 illustrates an embodiment of a network for teaching math in use. At 91 an administrator initiates a math expression to be solved by the students. This may be done automatically by a computer and the numbers and operators may be generated randomly by a processor and a random generator. All of the student devices may be identified on the network and initialized to receive input. At 93 a student may externally solve the expression given. At 95 the student may enter a solution to the queried math expression on an input means of the student device and the device may write the input to memory and make a note of the time. The system may be looped at 900 and repeat for a predetermined number of iterations or amount of time. After a testing or use session the memory of the student device may be accessed for review at 97. An internal clock with in the device may record the time it took the student to input the solution by comparing a time taken at 92 and 96 on the diagram.

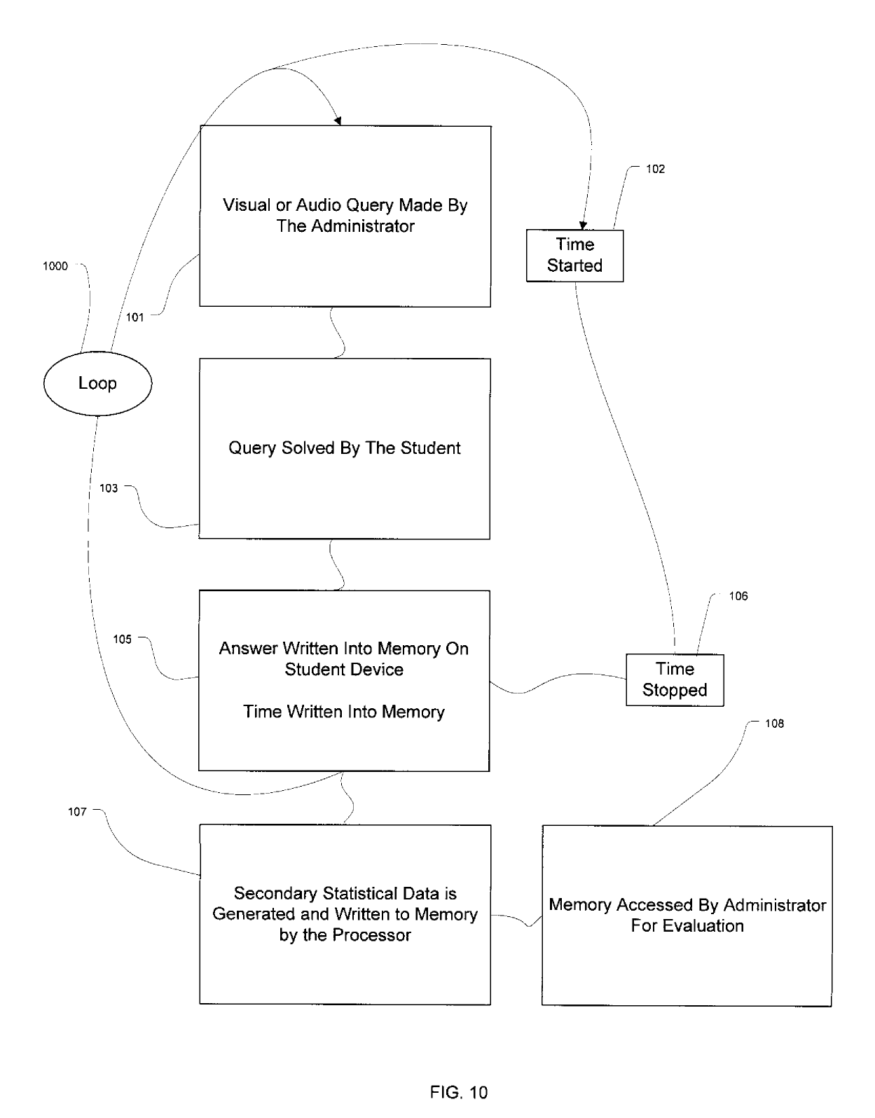

FIG. 10 illustrates an embodiment of a network for teaching math in use. At 101 an administrator initiates a math expression to be solved by the students. This may be done automatically by a computer and the numbers and operators may be generated randomly by a processor and a random generator. All of the student devices may be identified on the network and initialized to receive input. At 103 a student may externally solve the expression given. At 105 the student may enter a solution to the queried math expression on an input means of the student device and the device may write the input to memory and make a note of the time. The system may be looped at 1000 and repeat for a predetermined number of iterations or amount of time. An internal clock with in the device may record the time it took the student to input the solution by comparing a time taken at 102 and 106 on the diagram. A processor within the student device may process the raw data further and saved the processed data in memory at 107. After a testing or use session the memory of the student device may be accessed for review at 108.

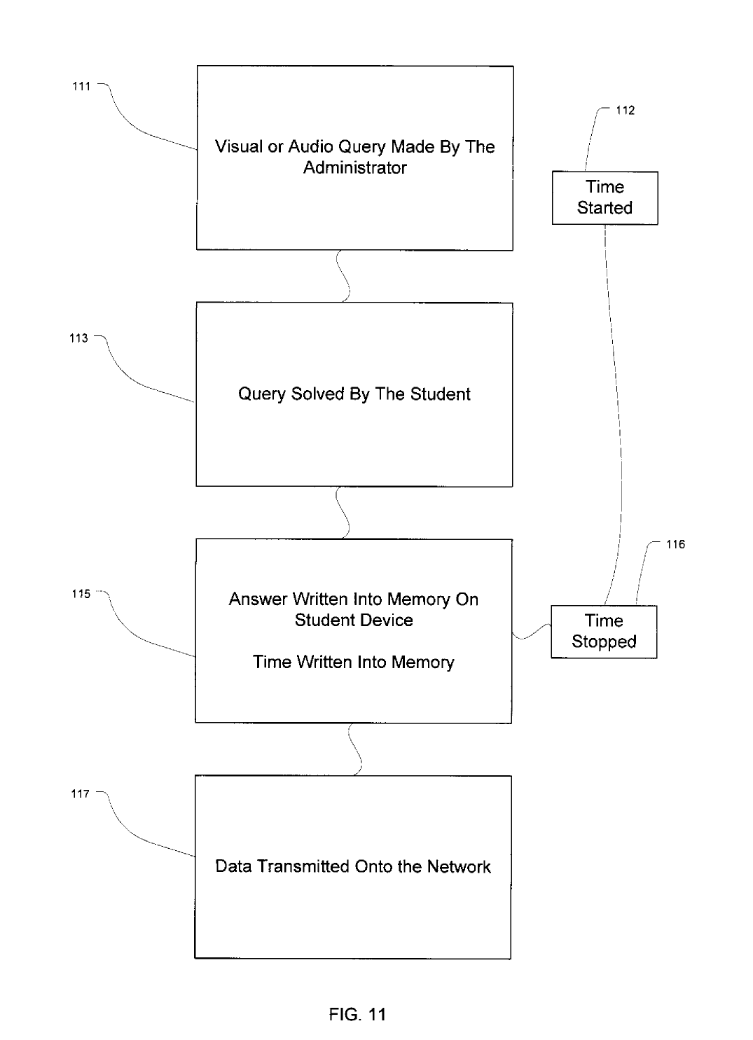

FIG. 11 illustrates an embodiment of a network for teaching math in use. At 111 an administrator initiates a math expression to be solved by the students. This may be done automatically by a computer and the numbers and operators may be generated randomly by a processor and a random generator. All of the student devices may be identified on the network and initialized to receive input. At 113 a student may externally solve the expression given. At 115 the student may enter a solution to the queried math expression on an input means of the student device and the device may transmit the data onto the network write the input to memory and make a note of the time. The device then may transmit the data onto the network at 117. An internal clock with in the device may record the time it took the student to input the solution by comparing a time taken at 112 and 116 on the diagram.

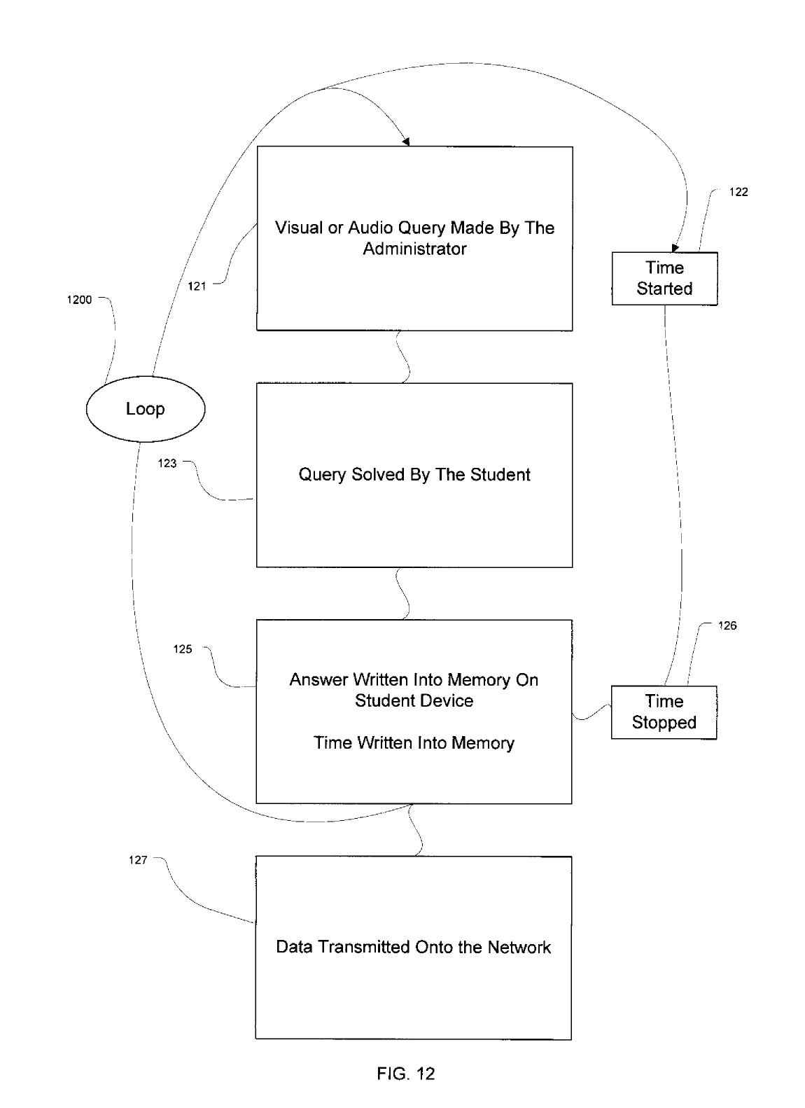

FIG. 12 illustrates an embodiment of a network for teaching math in use. At 121 an administrator initiates a math expression to be solved by the students. This may be done automatically by a computer and the numbers and operators may be generated randomly by a processor and a random generator. All of the student devices may be identified on the network and initialized to receive input. At 123 a student may externally solve the expression given. At 125 the student may enter a solution to the queried math expression on an input means of the student device and the device may write the input to memory and make a note of the time. The system may be looped at 1200 and repeat for a predetermined number of iterations or amount of time. The device then may transmit the data onto the network at 127. An internal clock with in the device may record the time it took the student to input the solution by comparing a time taken at 122 and 126 on the diagram.

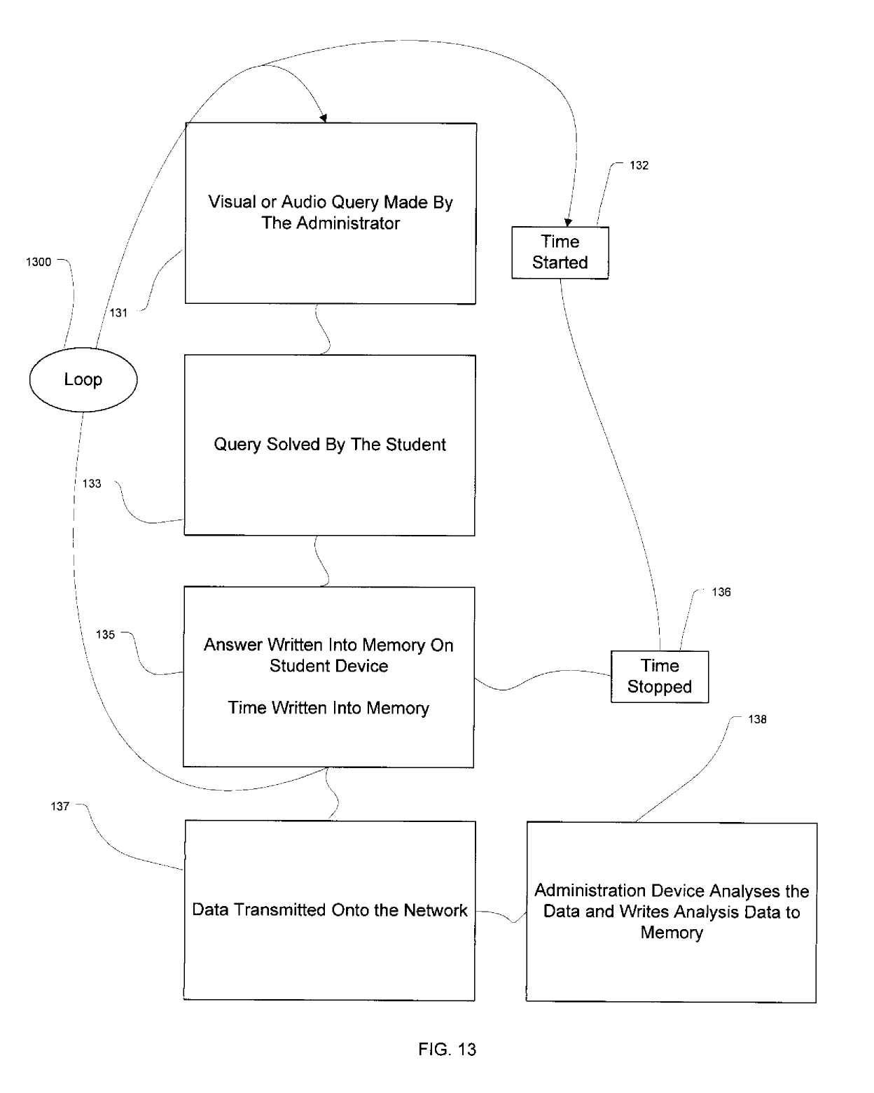

FIG. 13 illustrates an embodiment of a network for teaching math in use. At 131 an administrator initiates a math expression to be solved by the students. This may be done automatically by a computer and the numbers and operators may be generated randomly by a processor and a random generator. All of the student devices may be identified on the network and initialized to receive input. At 133 a student may externally solve the expression given. At 135 the student may enter a solution to the queried math expression on an input means of the student device and the device may write the input to memory and make a note of the time. The system may be looped at 1300 and repeat for a predetermined number of iterations or amount of time. The device then may transmit the data onto the network at 137. At 138 the administration device performs analysis of the data and writes the analysis results to memory. An internal clock with in the device may record the time it took the student to input the solution by comparing a time taken at 132 and 136 on the diagram.

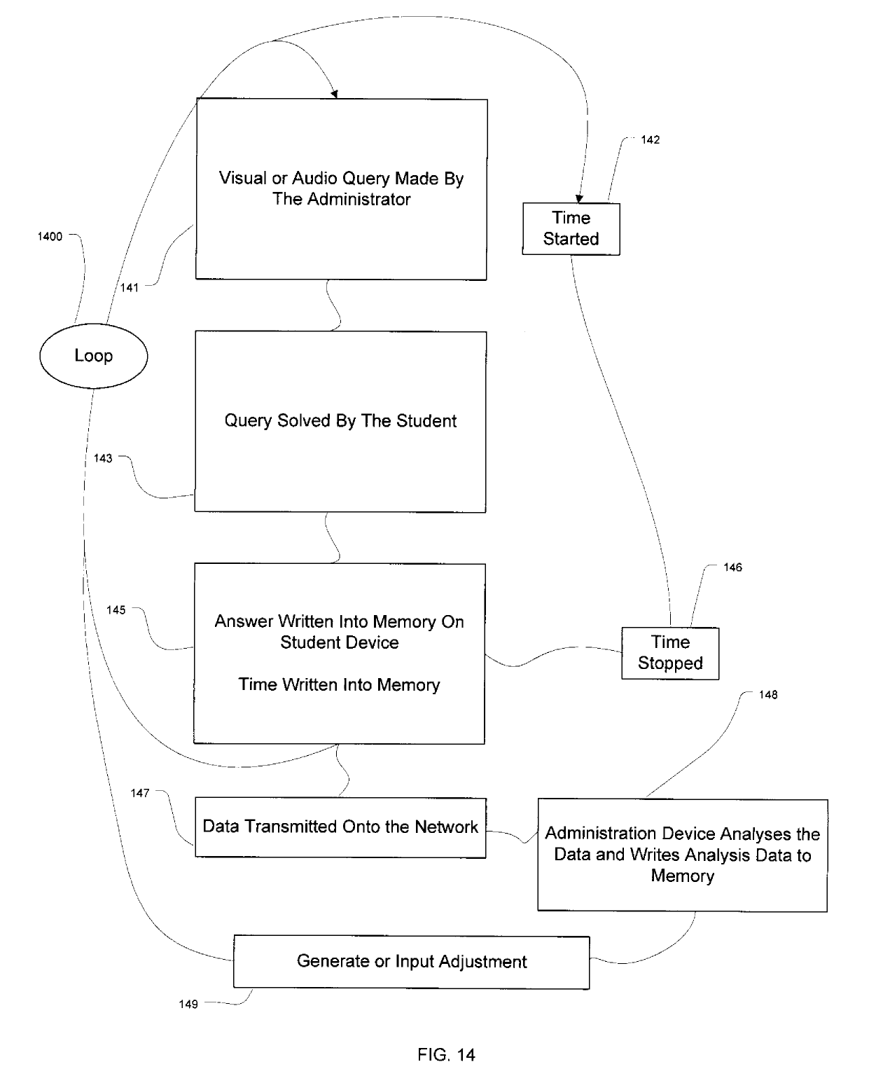

FIG. 14 illustrates an embodiment of a network for teaching math in use. At 141 an administrator initiates a math expression to be solved by the students. This may be done automatically by a computer and the numbers and operators may be generated randomly by a processor and a random generator. All of the student devices may be identified on the network and initialized to receive input. At 143 a student may externally solve the expression given. At 145 the student may enter a solution to the queried math expression on an input means of the student device and the device may write the input to memory and make a note of the time. The system may be looped at 1400 and repeat for a predetermined number of iterations or amount of time. The device then may transmit the data onto the network at 147. At 148 the administration device performs analysis of the data and writes the analysis results to memory and at 149 may make adjustments to the queries responsive to the results of the analysis. An internal clock with in the device may record the time it took the student to input the solution by comparing a time taken at 142 and 146 on the diagram.

In the foregoing Detailed Description, various features of the disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1-3. (canceled)

4. An apparatus for teaching mathematics comprising:
a network;
an administration device for transmitting a mathematical query over said network;
a student device for receiving said mathematical query over said network from said administration device and transmitting data over said network;
a memory for storing said data; and
wherein said data corresponds to said query.

5. The apparatus of claim 4 wherein said network is wireless.

6. The apparatus of claim 4 wherein said administration device is configured to receive said transmitted data from said student device.

7. The apparatus of claim 4 wherein said memory is in said administration device.

8. The apparatus of claim 4 wherein said memory is in said student device.

9. The apparatus of claim 7 wherein said data is stored in the memory of said administration device.

10. The apparatus of claim 4 wherein a first memory is in said administration device and a second memory is in said student device.

11. The apparatus of claim 10 wherein said mathematical query is stored in said first memory of said administration device.

12. The apparatus of claim 11 wherein said mathematical query is stored in said second memory of said student device.

13. The apparatus of claim 12 wherein said data is stored in said second memory of said student device.

14. The apparatus of claim 10 wherein said mathematical query is stored in said second memory of said student device.

15. The apparatus of claim 14 wherein said mathematical query is stored in said first memory of said administration device.

16. The apparatus of claim 15 wherein said data is stored in said second memory of said student device.

17. The apparatus of claim 4 wherein said administration device comprises a processor for processing said data.

18. The apparatus of claim 4 wherein said student device comprises a processor for processing said data.

19. A student device for use on a network for teaching mathematics comprising:
a numerical input able to receive an input from a user comprising single digits having a range of zero through nine;
a network interface for receiving a mathematical query and for communicating over a network; and
a memory for storing said input.

20. The student device of claim 19 further comprising a visual display for displaying a mathematical query and said input.

21. The student device of claim 19 wherein a mathematical query is stored in said memory.

22. The student device of claim 19 further comprising a processor for processing said input.

23. The student device of claim 19 further comprising a wireless network adaptor for communication over the network wirelessly.

24. The student device of claim 19 further comprising a unique identifier for identifying the device on the network.

25. The student device of claim 19 further comprising a timer for timing an interval between displaying said mathematical query and said input.

26. An administration device for use on a network for teaching mathematics comprising:
a memory for storing a mathematical query and an input corresponding to said mathematical query; and
a processor for processing said input and said mathematical query to develop a result.

27. The administration device of claim 26 further comprising a visual display for displaying said mathematical query and said input.

28. The administration device of claim 26 comprising a timer for timing an interval between displaying said mathematical query and said input.

29. The administration device of claim 26 further comprising a processor for processing said input.

30. The student device of claim 26 further comprising a wireless network adaptor for communication over the network wirelessly.

31. A method of using a network of devices for teaching mathematics comprising:
transmitting a mathematical query from an administration device that is communicating over a network;
receiving said mathematical query onto a student device having a unique identifier that is communicating over said network;
transmitting over said network a user input that corresponds to said mathematical query and that has been entered onto said student device; and
transmitting the unique identifier along with said user input.

32. The method of claim 31 further comprising timing an interval between receiving said mathematical query and transmitting said user input.
